(19) United States
(12) Patent Application Publication
(10) Pub. No.: US 2012/0323622 A1
(43) Pub. Date: Dec. 20, 2012

(54) Assessing Fitness of Drivers for Pending Trip Assignments

(75) Inventor: Michael Scott, Coquitlam (CA)

(73) Assignee: WEBTECH WIRELESS INC., Burnaby (CA)

(21) Appl. No.: 13/161,375

(22) Filed: Jun. 15, 2011

(51) Int. Cl. G06Q 10/00

(52) U.S. Cl. 705/7.14

(57) ABSTRACT

A system for assessing fitness of drivers for trip assignments includes a data processor adapted to communicate with recorders in vehicles for retrieving driving histories of drivers, and a terminal connected with the data processor. The terminal is used by a dispatcher for operating the data processor to construct trip definitions of pending trip assignments, append each of the trip definitions separately to the driving history of each of the drivers so as to form driver/trip assignment combinations of all drivers and all pending trip assignments, process the combinations through an hours-of-service engine to determine which combinations are legal under hours-of-service work rules, calculate a fitness rating for each legal combination, and analyze the fitness ratings of the legal combinations against one another to select the driver with best fitness for each pending trip assignment.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The subject matter of the present invention is directed generally to planning of driver and trip assignments and, more particularly, is concerned with an innovation for assessing fitness of drivers for pending trip assignments.

### BACKGROUND ART

In the commercial transportation services industry, typically a carrier is hired by a customer to provide one time or repeated transportation of goods by the carrier from and/or to the customer's location(s) within certain time constraints. The customer informs the carrier of its transportation requirements and constraints, for instance, the quantity of goods and the desired pickup and delivery times and dates. Typically, the carrier maintains a pool of commercial motor vehicles, such as trucks, and commercial drivers for the vehicles in order to be ready to provide the requested commercial transportation services for the customers. In providing this service, the carrier by law must ensure that its commercial drivers operate its commercial vehicles in accordance with regulations.

Currently, many jurisdictions have, in effect, hours of service (HOS) rules which regulate the driving hours of commercial drivers. The HOS rules are intended to prevent driver fatigue, by limiting the amount of time commercial drivers can spend operating commercial vehicles. Also, typically an electronic device, referred to as an electronic on-board recorder (EOBR), is attached to the commercial motor vehicle to provide an ongoing record of the amount of time the vehicle is being driven. The EOBR record may be accessed to check on the accuracy of logs completed by commercial drivers to record their hours of service. Government inspectors periodically conduct road side inspections of commercial drivers' logs to ensure the drivers are in compliance with the HOS regulations. Government auditors also conduct audits of records at the carrier's place of business to determine whether the carrier is overseeing its commercial drivers so as to ensure they operate its commercial vehicles in compliance with the HOS regulations.

Typically, the carrier employs a dispatcher to receive transportation service orders and time constraints from multiple customers and to plan the next few days of work for the carrier's commercial drivers. In making such plans, the dispatcher must ensure that the limitations of the HOS regulations are satisfied with respect to each commercial driver. In other words, the dispatcher must be able in a relatively short amount of time to assign any give day(s) worth of customer transportation service work to each commercial driver employed by the carrier in a manner that complies with the HOS regulations as applied to each commercial driver.

There is therefore a need for an innovation that will enable the dispatcher to perform assignment tasks on a timely basis and in an efficient manner after taking into consideration the constraints imposed by customers and the limitations imposed by government HOS regulations.

### SUMMARY OF THE INVENTION

The subject matter of the present invention provides such an innovation wherein the efficiency of the dispatcher is increased in identifying from a pool of drivers the driver having the best fitness for assignment to a particular trip assignment compared to the other drivers. The innovation allows a dispatcher to, first, determine which drivers in the pool are able, within the limits of the HOS regulations, to achieve the objectives of a particular trip assignment or set of trip assignments, and, then, compare those drivers with each other to determine which one has the best trip fitness for the trip assignment. Best trip fitness is determined from both regulatory and business value fitness perspectives to maximize driving time usage.

Accordingly, one aspect of the present invention is a system for assessing fitness of drivers for pending trip assignments which includes a data processor adapted to receive and store driving histories of drivers, and a terminal connected in communication with the data processor. The terminal is used by a dispatcher for operating the data processor to construct trip definitions of pending trip assignments, append each of the trip definitions separately to the driving history of each of the drivers so as to form driver/trip assignment combinations of all drivers and all pending trip assignments, process the driver/trip assignment combinations through an hours-of-service engine to determine which driver/trip assignment combinations are legal under hours-of-service work rules, calculate a fitness rating for each of the legal driver/trip assignment combinations, and analyze the fitness ratings for the legal driver/trip assignment combinations against one another to select the driver with best fitness for each pending trip assignment.

Another aspect of the present invention is a method for assessing fitness of drivers for pending trip assignments which includes the steps of receiving and storing driving histories of drivers, constructing trip definitions of pending trip assignments, appending each of the trip definitions separately to the driving history of each of the drivers so as to form drive/trip assignment combinations of all drivers and all pending trip assignments, processing the driver/trip assignment combinations through an hours-of-service engine to determine which driver/trip assignment combinations are legal under hours-of-service work rules, calculating a fitness rating for each of the legal driver/trip assignment combinations, and analyzing the fitness ratings for the legal driver/trip assignment combinations against one another to select the driver with best fitness for each pending trip assignment.

### BRIEF DESCRIPTION OF THE DRAWINGS

For clarity, the drawings herein are not necessarily to scale, and have been provided as such in order to illustrate the principles of the subject matter, not to limit the present invention.

FIG. 1 is a hardware block diagram showing interconnection of an EOBR and a dispatcher terminal by a data processor operable in accordance with the present invention for assessing fitness of drivers for pending trip assignments.

FIG. 2 is a flow diagram of an exemplary embodiment of steps of a method for assessing fitness of drivers for pending trip assignments in accordance with the present invention.

FIG. 3 is a detailed architectural block diagram of an exemplary embodiment of the modules of the system for assessing fitness of drivers for pending trip assignments in accordance with the present invention.

FIG. 4 illustrates a prior art example of a trip definition.

FIG. 5 illustrates an example of a composite driver's log formed by compiling recent past, current and future work activities of a driver that constitute a driver/trip assignment combination.

FIG. 6 illustrates a matrix diagram made up of multiple rows labeled pending trip assignments, crossed by multiple columns labeled drivers who are candidates for the trip assignments, with rates of utilization of drivers work time given at intersections of the multiple rows and columns being calculations of fitness of each driver for each pending trip assignment.

FIG. 7 illustrates an example of a data set more complicated than that of FIG. 6 and a few of the possible solutions of total fitness based on the data set using a known combinatorial optimization algorithm.

### DESCRIPTION OF EMBODIMENT(S)

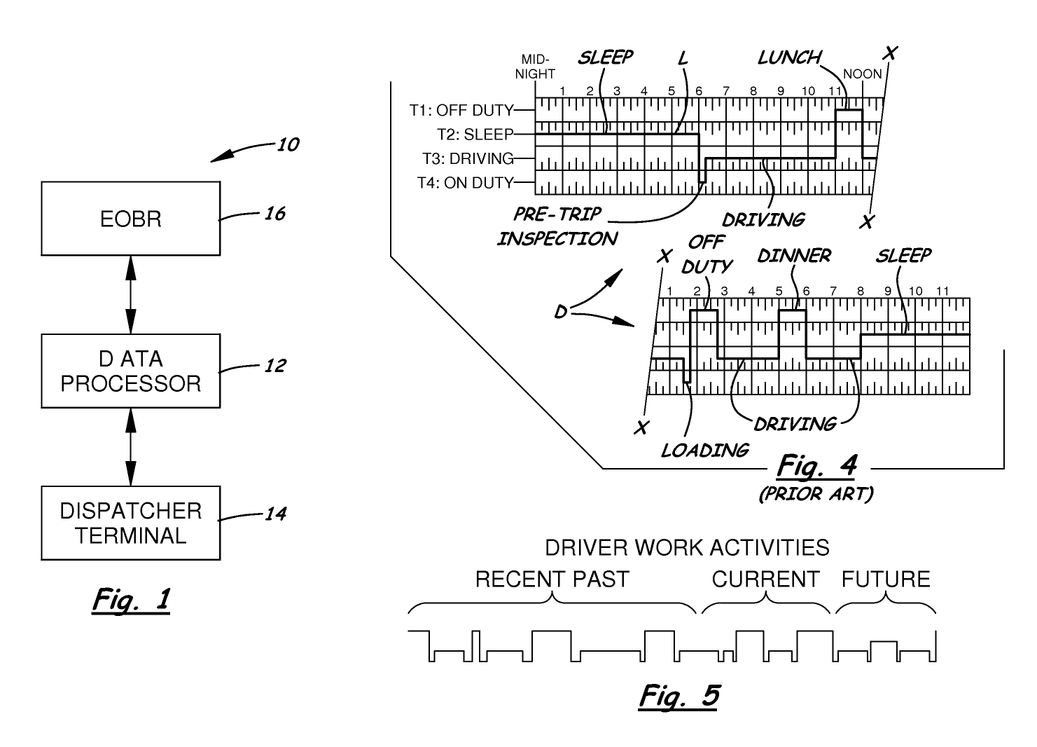

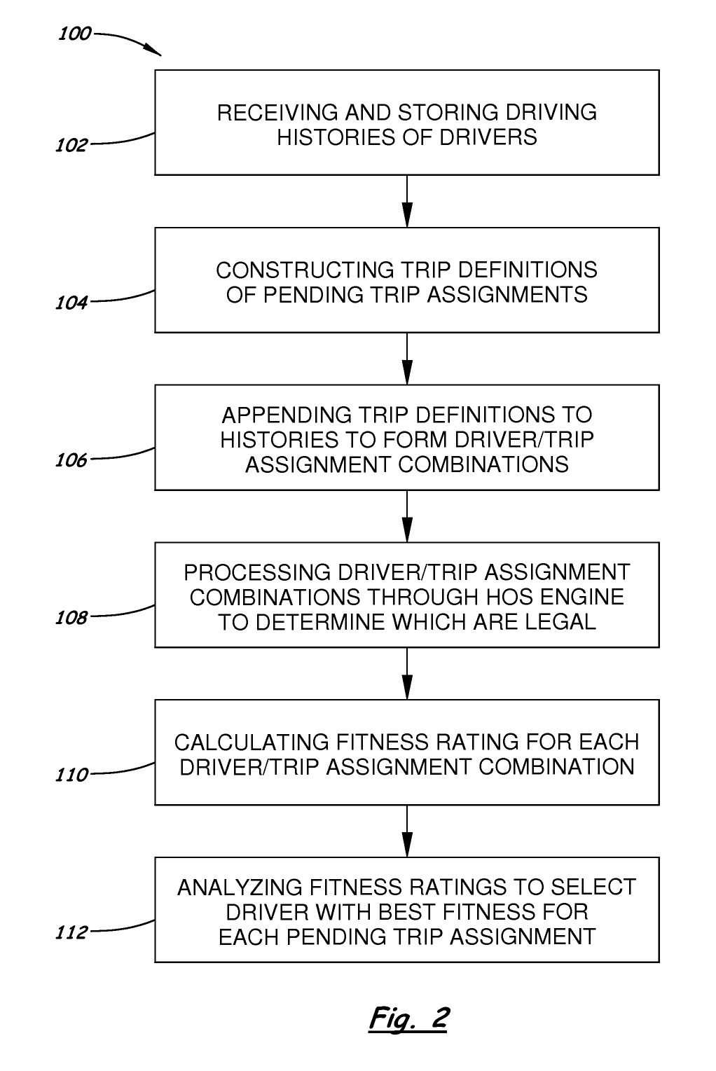

Referring now to FIG. 1, there is shown a general hardware diagram of a system, generally designated 10, for assessing fitness of drivers for pending (unassigned) trip assignments in accordance with the present invention. The system 10 includes a data processor 12 interconnecting a dispatcher terminal 14 and an electronic on-board recorder (EOBR) 16. (FIG. 2 illustrates an exemplary embodiment of the various modules of the data processor 12 and terminal 14 which will be described below.) Although in the system 10 as explained hereinafter the historical drive log data, or driving histories, are described as being retrieved from the recorder 16, it should be understood that, while that circumstance makes the dispatchers decisions more agile and timely, the process of evaluating best fitness to make optimal trip assignments can still function satisfactorily with difference sources of the driver log data. For instance, driver histories may be imported from another system, scanned from paper logs, or even manually entered.

Typically, the data processor 12 wirelessly interconnects the dispatcher terminal 14 to the recorder 16 in each vehicle (not shown). One recorder 16 is attached to each vehicle in a pool of commercial motor vehicles maintained by a carrier that is hired by customers to transport their goods within certain time constraints they specify. The recorders 16 facilitate the entry by drivers and maintenance of ongoing records of the amounts of time the vehicles are being driven by drivers in a pool also maintained by the carrier for operating its commercial motor vehicles. A dispatcher is employed by the carrier to use the terminal 14 to operate the data processor 12 to assess fitness of drivers for pending trip assignments in accordance with the method of present invention.

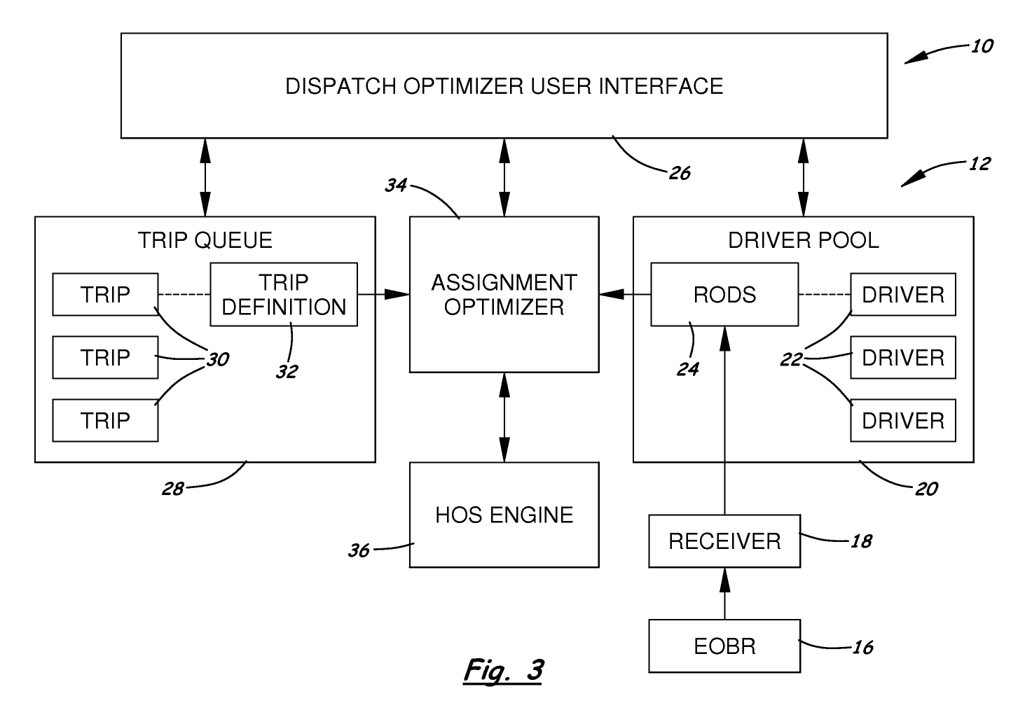

Referring to FIGS. 2 and 3, a flow diagram, generally designated 100, in FIG. 2 illustrates the steps of an exemplary embodiment of the fitness assessing method. A schematic diagram in FIG. 3 illustrates various modules of an exemplary embodiment of the fitness assessing system 10 for carrying out the method depicted in FIG. 2.

As per block 102 of the diagram 100 in FIG. 2, an initial step of the fitness assessing method involves using the terminal to retrieve the driving histories of drivers in the pool of the carrier either from the recorder 16 or from the data processor 12 in the case where the data processor 12 has been programmed to automatically retrieve the driving histories from the recorder 16. Thus, referring to FIG. 3, the data processor 12 typically is programmed to retrieve and update the driving histories of drivers in the form of drivers' logs from the recorders 16 in the vehicles via a communications receiver 18. The driving histories are then stored in a database 20, labeled “Driver Pool”, in multiple electronic files 22, labeled “Driver”, which are identified by the names or IDs of various drivers of the pool. The dispatcher then operates the data processor 12 via the terminal 14 to copy each driving history from the corresponding file 22 to a temporary storage module 24, labeled “RODS”.

As per next 104 of the diagram 100 in FIG. 2, another step of the method involves constructing trip definitions of pending trip assignments to determine whether the time constraints of each pending trip assignment can be satisfied within the limitations of the hours-of-service work rules. Referring to FIG. 4, there is illustrated an example of the makeup of a trip definition D. The trip definition D typically is a driver's log taking the form of continuous line L on a time graduated scale T having different superimposed levels T1-T4. The line L abruptly ascends or descends from one level to another as the driver's activities change from one category to another. In such way, the trip definition D provides a graphical representation of the duration of the driver's activities as plotted against the progression of time. The driver's activities, shown graphically as portions of the continuous line L, fall in four categories: (1) Off Duty, plotted at the highest level T1, which typically covers meals and rest stops; (2) Sleep, plotted at the next to highest level T2 which covers sleeping, such as in the vehicle sleeping compartment; (3) Driving, plotted at the next to lowest level T3, which covers driving the vehicle; and (4) On Duty (but not driving), plotted at the lowest level T4, which typically includes pre-trip inspection, fueling, repairs, loading and unloading.

Processing the trip definitions through an hours-of-service engine will determine whether the time constraints of each pending trip assignment can be satisfied within the limitations of the hours-of-service work rules. Referring to FIG. 3, to make this determination the dispatcher operates the data processor 12 via the terminal 14 using an interface 26, labeled “Dispatch Optimizer User Interface” to store all trip assignments, including pending trip assignments, in a database 28, labeled “Trip Queue” in multiple electronic files 30, labeled “Trip”. A trip definition is constructed in a module 32, labeled “Trip Definition” for each pending trip assignment and then processed by a module 34, labeled “Assignment Optimizer” through an hours-of-service engine 36, labeled “HOS Engine”. The hours-of-service engine 36 operates on the basis of a set of HOS work rules, which in a simplified example may be follows: (1) a day is 24-hour period that begins at the hour designated by the carrier; (2) a driver must have a minimum of 10 hours of off-duty and sleep combined every day; (3) a driver is limited to a maximum of 13 hours of driving in one day; and (4) a driver is prohibited from driving after 14 hours of on-duty and driving combined in a day.

As per step 106 of the diagram in FIG. 2, another step of the method involves appending each of the trip definitions separately to the driving history of each of the drivers so as to form drive/trip assignment combinations of all drivers and all pending trip assignments. Referring to FIG. 3, the dispatcher operates the data processor 12 via the terminal 14 to append a given trip definition of a pending trip assignment to a driving history of a driver using the dispatch optimizer user interface 26 and the assignment optimizer module 34. The driving history as well as each pending trip assignment can be drafted as a series of trip definitions in terms of the above categories of driver activities so as to build a composite log of the driver's (1) recent past activities, (2) current activities and (3) expected future activity, the latter encompassing the pending trip assignment. A composite drivers' log, an example of which is schematically illustrated in FIG. 5, constitute each the drive/trip assignment combination of all drivers and all pending trip assignments.

As per step 108 of the diagram 100 in FIG. 2, another step of the method involves processing the driver/trip assignment combinations through the hours-of-service engine 36 to determine which driver/trip assignment combinations are legal under hours-of-service work rules. Referring to FIG. 3, to make this determination of legality the dispatcher again operates the data processor 12, via the terminal 14, by using the interface 26 and the assignment optimizer module 34 to process each driver/trip assignment combination of FIG. 5 through the hours-of-service engine 36.

As per step 110 of the diagram 100 in FIG. 2, another step of the method involves calculating a fitness rating for each of the driver/trip assignment combinations determined to be legal by the hours-of-service engine 36. The fitness rating calculation should meet a specified predetermined criterion, for example, the business goal of filling the maximum amount of available driver time within each of the drivers shifts and thus leaving the least amount of drive time remaining at the end of the trip assignment. In other words, the goal is maximal usage of drivers available hours. The fitness rating is achieved by calculating the rate of utilization of drivers work time, or the ratio of drive time available entering a trip assignment (and/or each shift) against the drive time remaining leaving the trip assignment (and/or each shift). The drive time available entering the trip assignment will be contingent on what is the recent past and current activity of the drivers.

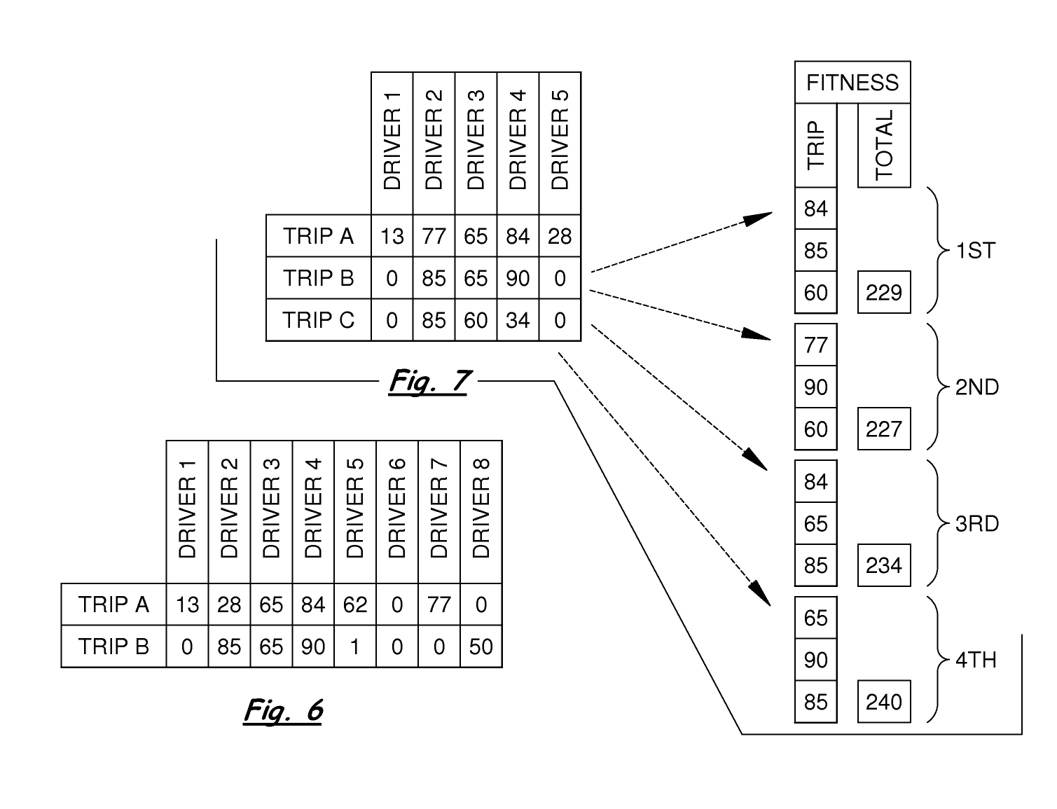

In FIG. 6, there is shown a matrix diagram made up of multiple rows labeled pending trip assignments, crossed by multiple columns labeled drivers who are candidates for the trip assignments, with rates of utilization of drivers work time given at intersections of the multiple rows and columns being the calculations of fitness of each driver for each pending trip assignment. The quantities of the drive time available and remaining to form the ratios, or rates of utilization, are gained from the composite drivers' log, as shown in FIG. 5, which constitute each of the drive/trip assignment combinations of all drivers and all pending trip assignments.

There may be different types of formula used to define fitness. But they need to have a relationship to the bottom line of the carrier. A formula that rates the utilization of drivers work time, such as the ratio calculated in step 110, is linked to the carrier's bottom line. For instance, if five drivers are utilized at 80% to satisfy a set of work requirements, only four drivers of those five are required to do the same work if they can be utilized at 100%. That is a saving of one driver's time cost or the fifth driver becomes available for additional work load. So the result can be viewed as either: (1) cost reduction: less drivers required to do current work; or (2) increased capacity: do more work done with current drivers.

As per step 112 in FIG. 2, a last step of the method 100 involves the assignment optimizer module 34 analyzing the fitness ratings for each of the legal driver/trip assignment combinations against one another to select the driver with best fitness for each pending trip assignment. One way of making this selection is to calculate and sum all fitness losses. Fitness loss is the cost of not assigning the optimal driver to a trip assignment, i.e. the difference between the optimal driver and the selected driver. Referring to FIG. 6, there are two scenarios involved in evaluation of total fitness of the drivers against each other. In scenario one, driver 7 is selected for trip A even though driver 7 only has the second highest fitness rating (77) after the highest rating (84) of driver 4 for trip A. Driver 4 cannot be selected for trip A because driver 4 is selected for trip B since driver 4 has the highest rating (90) and since the latter is higher than the fitness rating (84) of driver 4 for trip A. The total fitness loss is 7 [84−77] for trip A plus 0 [90−90] for trip B, which equals 7, the sum of all losses in scenario one. In scenario two, driver 4 is selected for trip A since driver 4 has the highest rating (84) for trip A even though not as high as the fitness rating (90) of driver 4 for Trip B. Driver 2 having the second highest fitness rating (85) after the highest rating (90) of driver 4 is selected for trip B. The total fitness loss is 0 [84−84] for trip A plus 5 [90−85] for trip B, which equals 5, the sum of all losses in scenario two. Thus, it is more advantageous to use scenario two since there are less losses with that solution.

A human dispatcher cannot perform this analysis or evaluation in an expeditious manner where there are more than just a few drivers and pending trip assignments; for larger data sets there are too many possible permutations. Referring to FIG. 7, there is illustrated an example of a data set much more complicated than that of FIG. 6 and a few of the possible solutions (of some sixty possible solutions) of total fitness based on the data set using a known combinatorial optimization algorithm. The known algorithm is referred to as the Hungarian Method, which solves the assignment problem is polynomial time and was developed and published by Harold Kuhn in 1955. One web reference is http://en.wikipedia.org/wiki/Hungarian_algorithm, hereby incorporated herein by reference thereto. This algorithm can solve the assignment problem very quickly for data volumes to be expected in these type cases in commercial transportation services industry. It is an iterative matrix manipulation approach that does not require calculation of all possible outcomes. Referring again to FIG. 7, the optimal solution is the fourth scenario having a total fitness of 240 [65+90+85] which significantly sacrifices on trip A, but is optimal for all drivers and the remainder of the trips.

The present invention applies features of project planning software (leveling of tasks based on constraints) to the commercial transportation services industry. In so doing dispatchers are provided with the ability to process hundreds of drivers, evaluate one or more drivers against a trip assignment or set of trip assignments, and identify the driver of best fitness to the pending trip assignments almost effortlessly. The present invention also can be used to generate a trip plan for a driver to follow that shows flexible segments and general trip flexibility, continually monitor a driver's actions against the assigned trip plan, warn a driver when or before a trip plan is in jeopardy and thereby assists in keeping the driver to the plan.

The present invention also permits the dispatcher to re-evaluate drivers already selected for best fitness for a particular trip assignment in light of subsequent changes affecting either driver availability or trip requirement. For instance, a driver who encounters a problem in finishing his current trip (driving activity) that will make him unavailable to start the next trip as planned may necessitate a re-evaluation of the drivers for best fitness for that particular trip assignment. Also, a trip that has been assigned to a driver but which turns out no longer necessary or its time constrain has changed may necessitate a re-evaluation of the drivers for best fitness for the other trip assignments. The present invention allows these unforeseen but inevitable changes to be handled by a dispatcher on short notice by re-evaluation of the driver pool against trip assignments to determine if any changes in trip assignments should be made to maintain optimal use of drivers. This means re-evaluating already assigned drivers and allowing their assigned trips to be re-assigned.

In the description herein, embodiments disclosing specific details have been set forth in order to provide a thorough understanding of the invention, and not to provide limitation. However, it will be clear to one having skill in the art that other embodiments according to the present teachings are possible that are within the scope of the invention disclosed. All parameters, dimensions, materials, and configurations described herein are examples only and actual values of such depend on the specific embodiment.

What is claimed is:

1. A system for assessing fitness of drivers for pending trip assignments, comprising:
a data processor adapted to receive and store driving histories of drivers; and
a terminal connected in communication with said data processor and used by a dispatcher for operating said data processor to:
construct trip definitions of pending trip assignments,
append each of the trip definitions separately to the driving history of each of the drivers so as to form driver/trip assignment combinations of all drivers and all pending trip assignments,
process the driver/trip assignment combinations through an hours-of-service engine to determine which driver/trip assignment combinations are legal under hours-of-service work rules,
calculate a fitness rating for each of the legal driver/trip assignment combinations, and
analyze the fitness ratings of the legal driver/trip assignment combinations against one another to select the driver with best fitness for each pending trip assignment.

2. The system of claim 1 wherein said terminal also is used by the dispatcher to operate said data processor to re-evaluate a best fitness selection in light of any change subsequently affecting at least one of driver availability or trip requirement.

3. The system of claim 1 wherein the dispatcher copies the stored driving histories using said terminal to construct said trip definitions of pending trip assignments.

4. The system of claim 2 wherein the driving histories are stored in electronic files in a database of said data processor.

5. The system of claim 1 wherein said trip definitions are processed through said hours-of-service engine to determine whether time constraints of each pending trip assignment can be satisfied within limitations of hours-of-service work rules.

6. The system of claim 1 wherein said driving history of each driver, to which is appended each trip definition, includes recent past and current driving history.

7. The system of claim 1 wherein said pending trip assignments are stored in a database of the data processor in a queue of electronic files representing trip assignments by the dispatcher operating said data processor via said terminal using a user interface.

8. The system of claim 7 wherein the dispatcher operates said data processor via said terminal to build a series of trip definitions in the form of a composite log of recent past, current and expected future activities of a driver, the latter encompassing the pending trip assignment.

9. The system of claim 1 wherein the fitness rating is based on the ratio of drive time available entering the trip assignment against the drive time remaining leaving the trip assignment.

10. The system of claim 1 wherein the fitness ratings of the legal driver/trip assignment combinations are analyzed against one another in an assignment optimizer using a combinatorial optimization algorithm.

11. A method for assessing fitness of drivers for pending trip assignments, comprising the steps of:
receiving and storing driving histories of drivers;
constructing trip definitions of pending trip assignments;
appending each of the trip definitions separately to the driving history of each of the drivers so as to form driver/trip assignment combinations of all drivers and all pending trip assignments;
processing the driver/trip assignment combinations through an hours-of-service engine to determine which driver/trip assignment combinations are legal under hours-of-service work rules;
calculating by using a data processor a fitness rating for each of the legal driver/trip assignment combinations; and
analyzing the fitness ratings of the legal driver/trip assignment combinations against one another to select the driver with best fitness for each pending trip assignment.

12. The method of claim 11 wherein the driver histories are stored in electronic files in a database of a data processor.

13. The method of claim 12 wherein said constructing the trip definitions of pending trip assignments includes copying the driver histories by the dispatcher using a terminal.

14. The method of claim 11 further comprising re-evaluating a best fitness selection in light of any subsequent change affecting at least one of driver availability or trip requirement.

15. The method of claim 11 further comprising processing the trip definitions through the hours-of-service engine to determine whether time constraints of each pending trip assignment can be satisfied within limitations of hours-of-service work rules.

16. The method of claim 11 wherein said driving history of each driver, to which is appended each trip definition, includes recent past and current driving history.

17. The method of claim 11 further comprising storing the pending trip assignments in a database of the data processor in a queue of electronic files representing trip assignments by the dispatcher operating the data processor via a terminal using a user interface.

18. The method of claim 17 wherein the dispatcher operates the data processor via the terminal to build a series of trip definitions in the form of a composite log of recent past, current and expected future activities of a driver, the latter encompassing the pending trip assignment.

19. The method of claim 11 wherein the fitness rating is based on the ratio of drive time available entering the trip assignment against the drive time remaining leaving the trip assignment.

20. The method of claim 11 wherein the fitness ratings of the legal driver/trip assignment combinations are analyzed against one another in an assignment optimizer using a combinatorial optimization algorithm.
